(19) United States
(12) Patent Application Publication
(10) Pub. No.: US 2018/0098519 A1
(43) Pub. Date: Apr. 12, 2018

(54) IMPROVEMENT TO TEAT CUP, MILKING HEAD AND MILKING OPERATIONS

(71) Applicant: MILKOMAX, SOLUTIONS LAITIÈRES INC., Sainte-Monique (CA)

(72) Inventor: Victor ROUSSEAU, Nicolet (CA)

(73) Assignee: MILKOMAX, SOLUTIONS LAITIÈRES INC.

(21) Appl. No.: 15/567,114

(22) PCT Filed: Apr. 8, 2016
(86) PCT No.: PCT/CA2016/050405

§ 371 Date: Oct. 17, 2017

Related U.S. Application Data
(60) Provisional application No. 62/150,931, filed on Apr. 22, 2015.

(51) Int. Cl. A01J 5/08

(52) U.S. Cl. CPC A01J 5/08; A01J 5/04

(57) ABSTRACT

An improved teat cup, teat cup sleeve, milking machine and milking method provides cleaner milk by drawing air into the milk stream from away from the teat cup. The teat cup may include an air duct having a first end in fluid communication with the milk conduit extending outside of the shell to a second end located away from the shell of the teat cup. The air duct may form part of an air passage that extends between the milk conduit and an air inlet which allows control of the source, flow and purity of air entering the milk stream.

### TECHNICAL FIELD

The present invention relates to the field of milking devices and methods and more particularly to the field of teat cups.

### BACKGROUND

Modern milking machines typically comprise a milking head on which teat cups, most commonly one per teat are arranged. In automatic milking head, teat cups are affixed to individual teats automatically.

Teat cups typically use a flexible sleeve which may or may not be considered a part of the teat cup. Typically, teat cups comprise a rigid outer shell into which is received a flexible sleeve. While the flexible sleeve can be provided as an integral part of the teat cup, the flexible sleeve is a wear part, and as such it is typically provided separately from the teat cup as a replaceable part.

In teat cups that use flexible sleeves, the sleeve is typically a food-grade rubber or silicone sock that sits in the teat cup and creates an enclosed chamber between the teat cup outer wall and the flexible sleeve. An air conduit, called a vacuum line, applies a pulsating (partial) vacuum between in the enclosed chamber to cause the appropriate massaging effect. Suction is applied intermittently to the vacuum line to cause the opening and collapsing of the flexible sleeve around the teat of the animal being milked.

The teat of an animal being milked is inserted into the sleeve and a milk line linking the inside of the flexible sleeve to the milk-collection line or receptacle carries the milk away, typically by suction applied to the milk conduit.

For the proper functioning of the mechanism, an air inlet is provided in the milk line or in communication therewith. This is typically, a very small hole communicating from the milk line to the outside of the teat cup.

The air that is received through the air inlet flows directly into the milk line and mixes with the milk. Since the air inlet is at the bottom of the teat cup, the air inlet draws air from near the ground underneath the animal (typically a tie stall or milking stall) which is usually unclean and covered in excrements, hay and feed. Urine or faeces may splash onto the air inlet. Moreover, the teat cups themselves are usually moved around by a machine before/after milking and may rub against the animal being milked, the ground, or food, excrements or other impure substances at teat cup-level. All these things provide an opportunity for impurities to enter the milk line.

Another disadvantaged to having an exposed air inlet is that it may be plugged or otherwise obstructed by debris. This can lead to problems during the milking operation, such as loss of suction. As a result of the restricted inflow of air, milking operations may take longer or fail to completely draw the milk. As such, the speed of the milking operation and output may be negatively affected. It is also envisaged that in certain cases the teat may even be harmed. For these reasons, the air inlet must be kept clean, which implies a certain maintenance burden. For example in current designs, operators often need to clean air inlets regularly and must carry tools and therefor.

Moreover, with known designs, there is no way to regulate the flow of air coming in through the inlet.

### SUMMARY

Provided are teat cups, teat cup sleeves, methods and milking robots as claimed, illustrated and described herein.

In accordance with a first broad aspect is provided a teat cup. The teat cup comprises a shell having an upper aperture and a milk conduit and defining a semi-enclosed sleeve-receiving space therebetween, the semi-enclosed sleeve-receiving space being sealable around the upper aperture opening and the milk conduit by a flexible sleeve to define a chamber between the shell and the flexible sleeve. The teat cup also comprises a vacuum conduit defining a fluid passage from the chamber to the exterior of the shell such that the application of a suction to the fluid passage causes a vacuum to be applied within the chamber. The teat cup also comprises an air duct having a first end in fluid communication with the milk conduit extending outside of the shell to a second end located away from the shell of the teat cup.

The second end may be located away from an exterior surface of the shell, at a location less susceptible to be the site of contaminants such as dirt or animal fecal matter.

In accordance with another broad aspect is provided a teat cup sleeve for lining the inside of a teat cup shell of a teat cup. The teat cup sleeve comprises a first longitudinal end comprising a teat-receiving opening and a mouth configured to form a seal around an upper aperture of the teat cup shell. The teat cup sleeve also comprises a circumambient flexible wall extending longitudinally from the first longitudinal end towards a second longitudinal end and defining a teat-receiving space. The teat cup sleeve also comprises a milk conduit extending outwards at the second longitudinal end to traverse the teat cup shell when installed for drawing milk away from the teat-receiving space towards a milk pump located outside of the teat cup. The teat cup sleeve also comprises an air duct having a first end in sealed fluid communication with the milk conduit extending outside of the sleeve to a second end located away from the sleeve such that when the sleeve is installed in a teat cup shell, the air duct communicates air located away from the teat cup with the milk conduit.

In accordance with another broad aspect is provided a teat cup comprising an outer wall, a flexible inner wall, a chamber between the outer wall, a vacuum conduit defining a fluid passage from the chamber across the outer wall such that the application of a suction to the fluid passage causes a vacuum to be applied within the chamber, a teat-receiving space inside the flexible inner wall, a milk duct outwards from the teat-receiving space for drawing milk away from the teat-receiving space towards a milk pump located outside of the teat cup, and an air duct having a first end in sealed fluid communication with the milk duct extending away from the teat cup to communicate air located away from the teat cup with the milk duct.

In accordance with another broad aspect is provided a method of milking an animal. The method comprises placing a teat cup having an outer wall, a flexible inner wall, and a chamber therebetween around a teat of the animal such that the teat penetrates a teat-receiving space defined at least in part by the inner wall, creating a pulsating vacuum in the chamber, applying suction to the teat-receiving space to draw milk into a milk duct away from the teat towards a milk reservoir, and drawing air into the milk duct from a location away from the teat cup.

In accordance with another broad aspect is provided a milking robot comprising animal processing equipment including a milking head, the milking robot comprising at least one teat cup provided on the milking head, a milk conduit for drawing milk away from an interior of the teat cup, and an air passage in fluid communication with the milk conduit for drawing air from away from the teat cup into the milk conduit.

In accordance with another broad aspect is provided a milking head comprising at least one teat cup, a milk passage in fluid communication with the teat cup, and a vacuum conduit defining a fluid passage to the teat cup for providing thereto a pulsating vacuum. The milking head also comprises an air duct having a first end at an air inlet in the milk passage and extending away from the milk passage to a second end located away from the milking head.

### BRIEF DESCRIPTION OF THE DRAWINGS

The invention will be better understood by way of the following detailed description of embodiments of the invention with reference to the appended drawings, in which:

FIG. 1 is a front perspective view of a teat cup according to a first non-limiting example;

FIG. 2 is a front cross-sectional view of the teat cup of FIG. 1;

FIG. 3 is a side elevation cross-sectional view of the air duct and the vacuum duct of the example of FIG. 1;

FIG. 4, which is a perspective view of the air duct and the vacuum duct of the example of FIG. 1;

FIG. 5 shows a perspective view of a cow milking head comprising four teat cups according to the example of FIG. 1;

FIG. 6 shows a perspective view of a teat cup according to another non-limiting example;

FIG. 7 shows a perspective view of a cow milking head comprising four teat cups according to the example of FIG. 6; and

FIG. 8 is a front cross-sectional view of a teat cup according to another example.

### DETAILED DESCRIPTION

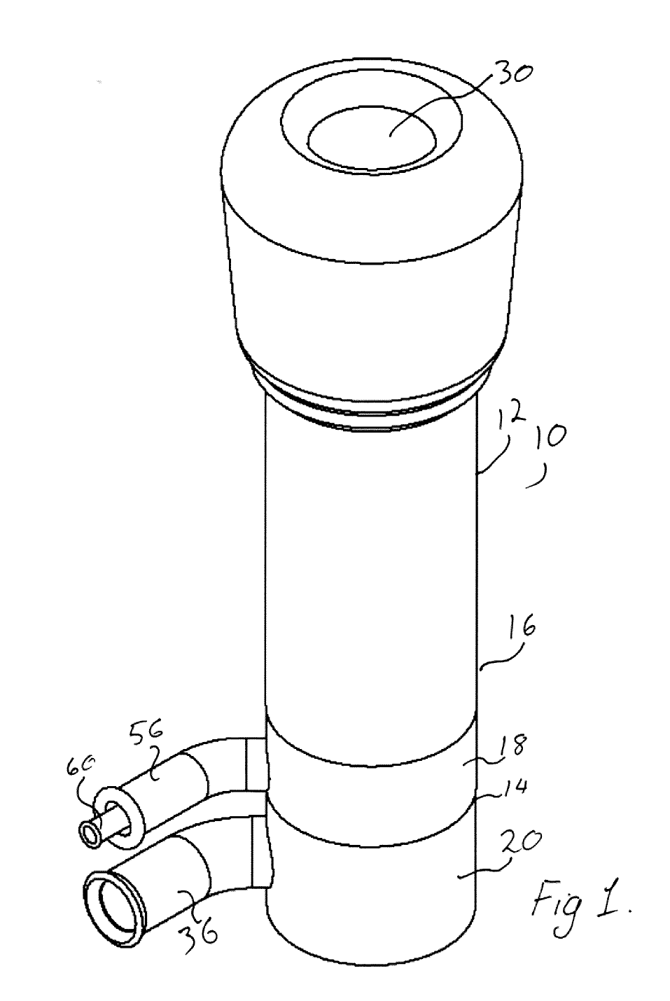

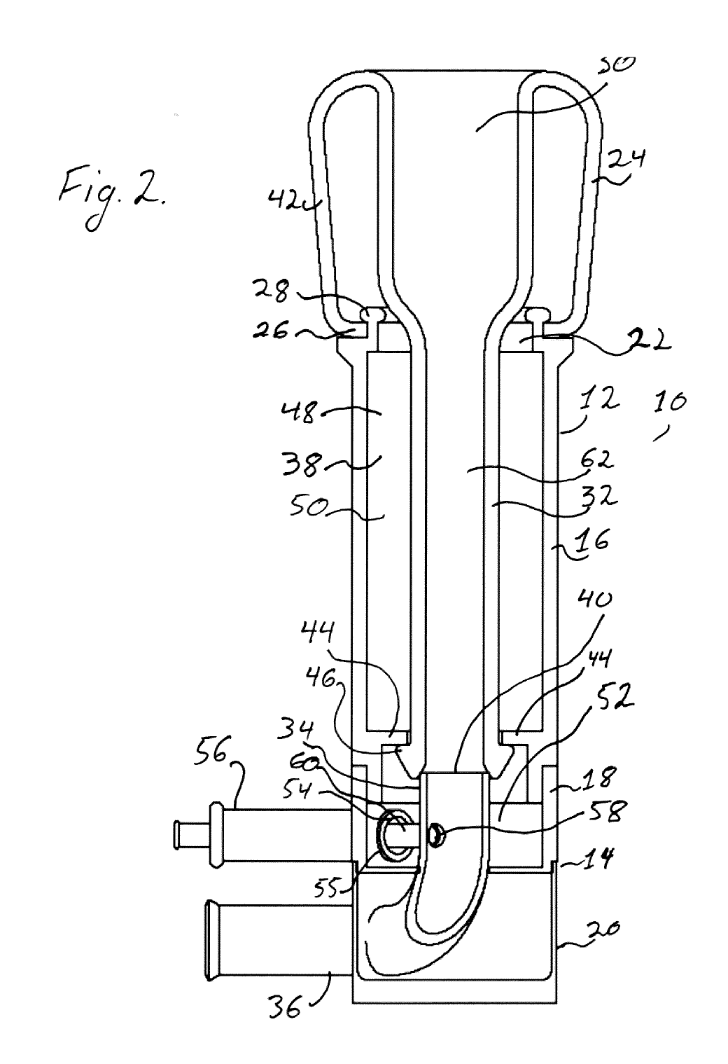

FIG. 1 shows a teat cup 10. The teat cup comprises a shell, here a rigid shell, which is composed of a base 14 and an outer wall 16, which is here a circumambient wall. As can be better seen in FIG. 2, which shows a front cross-sectional view of the teat cup of FIG. 1, the base 14 in this example is made of two parts, an upper base portion 18 and a lower base portion 20. However it should be understood that the base could be made of a single piece or be unitary with the outer wall 16.

A sleeve 24 is provided to the teat cup 10. In this example, the sleeve lines the inside of the teat cup shell 12 and is generally disposed in the same way lengthwise as the teat cup. At a first longitudinal end, namely the upper end, the sleeve 24 comprises a mouth 26 which, when installed seals around the upper aperture 22 of the shell 12. In this example, the mouth is configured to form a seal by snap-fitting over a lip 28 in the outer wall 16 around the upper aperture 22. But in alternate embodiments, the mouth may connect by other means, including by friction fit or even by weld or overmolding to make a more permanent connection. On the upper end, the sleeve 24 comprises a bumper section 42.

The sleeve 24, also has a teat-receiving opening 30 at the upper longitudinal end. This is where the teat is inserted for milking.

The shell 12 has an upper aperture 22. In this context, the term upper and lower indicate respective longitudinal end areas of the teat cup, the upper one being on the side from which the teat is received. In cow milking operations on a standing cow, that end would be facing up to receive a hanging teat.

The shell 12 defines a semi-enclosed space 38 in which the sleeve 24 is received. As described herein, the sleeve 24 in this example is a removable sleeve; however other embodiments may feature permanent sleeves.

The shell 12 also has a milk conduit 34. The shell 12's milk conduit 34 is a configuration for allowing milk to go from the inside of the shell 12 through it to the other side. In this particular example, the sleeve 24 does not protrude outside of the shell 12 on the lower side but forms a fluid communication connection with the milk conduit 34 within the semi-enclosed space 38. More specifically, the milk conduit 34 comprises a milk duct 36 that protrudes into the semi-enclosed space 38 and extends to a source aperture 40 where it connects with the sleeve 24 in a sufficiently sealing manner. Similarly to the mouth 26 and upper aperture 22, many connections are possible, here a press-fit configuration is used which forces the sleeve 24 to firmly abut the source aperture 40 forming a sufficient seal to prevent leaking milk.

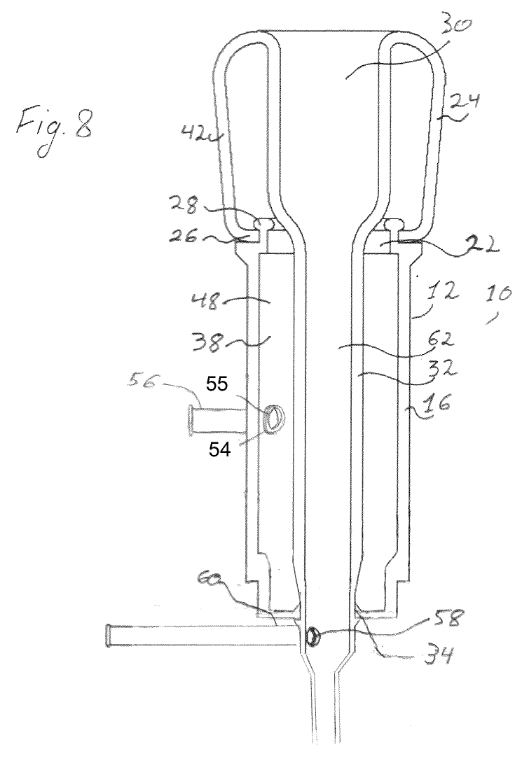

It will be noted that this embodiment is an exemplary. Other embodiments exist. For example, in another embodiment herein called the through-sleeve embodiment, the sleeve 24 may protrude outside of the shell 12 on the lower side. An example is illustrated in FIG. 8. There, milk conduit 34 may take the form of a bore or hole in the shell 12 dimensioned to receive the lower end of the sleeve 24. The hole is thus lined by the sleeve such that the shell 12 does not come into contact with the milk. The through-sleeve typically terminates in a milk duct itself, which is part of the milk passage from teat towards a milk pump pumping or towards a milk line or reservoir. In one example, the through-sleeve's milk duct terminates in a connection that is configured to be connected to the milk line of a milking machine.

The body of the sleeve 24 comprises a circumambient flexible wall 32 which when installed in the teat cup 10 defines a teat-receiving space 62 wherein a teat can be received for milking. The shell 12 and the sleeve 24 define between them a chamber 48. More particularly, the outer wall 16, base 14, circumambient flexible wall 32 together enclose the chamber 48, in this example between the sealed connection of the mouth 26 and the upper aperture 22 and the sealed connection of the sleeve 24 and the milk conduit 34 of the shell 12. At the lower end of the sleeve, the sleeve comprises a milk conduit which meets with the milk conduit of the shell 12 to permit flow of milk out of the teat cup 10.

In order to allow a press-fit connection of the lower end of the sleeve 24 into the shell 12, abutting posts 44 are provided inside the semi-enclosed space 38 to abut against a lip 46 in the sleeve. However, it will be noted that while the lower end of the sleeve 24 presses against the whole circumference source aperture 40 of the milk conduit 36 so as to seal with the milk conduit 36 of the shell 12, the abutting posts 44 do not surround the entire lip 46. Holes are left between the abutting posts 44 to ensure that the upper section 50 of the chamber 48 above the abutting posts 44 and the lower section 52 of the chamber 48 below the abutting posts 44 remain in fluid communication together. In an alternative embodiment, the area where here we have the lower section 52 of the chamber 48, which here is below the connection between sleeve 24 and the shell 12 specifically here at the milk conduit 34 could be completely cut off from the chamber 48 provided that the vacuum conduit 54 is moved to be in fluid communication with the chamber 48.

A vacuum conduit 54 defines a fluid passage from the chamber 48 to the outside of the shell 12. This is used to impart a pulsating vacuum to the chamber 48. It will be appreciated that the term vacuum herein is not meant to designate an absolute vacuum, but rather the type of pressure changes that are useful in a teat cup for milking. In one example, the milk duct 36 may be provided with a constant suction pressure for drawing milk from the teat. In such condition, absent suction within the chamber 48, the flexible wall 32 will collapse inwardly to close up the teat-receiving space 62 against a teat received therein and apply pressure thereto. Applying a vacuum in the chamber 48 that counteracts the vacuum provided in the teat-receiving space 62 by the suction in the milk duct 36 causes the flexible wall 32 to relax the pressure applied and draw away from the teat. The vacuum conduit 54 may be connected to equipment for creating the desired pulsation/vacuum; in this example, the vacuum conduit 54 comprises a vacuum duct 56 which connects to the shell 12 at a vacuum port hole 55 and which is configured to connect on the other end to a vacuum hose of a milking machine. The vacuum pulse provided may be an oscillating vacuum pressure that intermittently allows the flexible wall 32 to close up and apply pressure on a teat and relax the pressure applied. In one example an oscillating pressure varying between a suction of 14 PSI and no suction (OPSI) is applied. Of course, this is merely an example and other pressure functions or pulsating effects may be applied.

For certain reasons, for example to ensure a constant unidirectional flow of milk with no back-flow, no loss of suction, and/or to ensure that excessive or harmful suction is not applied to the skin of a teat, an air inlet 58 is provided to permit the ingress of outside air into the milk conduit 34. The ingress of air into the milk conduit 34 serves important functions. If the airflow is not available or insufficient, the drawing of the milk from the teat will be affected. This can affect the quality of milk as well as the throughput available from the teat. Permitting the flow of air into the milk conduit 34 allows the application of optimal suction to be applied to the teat.

The air inlet 58 provided here is not exposed to outside element but is shielded from the exterior by a connected air duct 60 which provides fluid communication with the milk conduit extending outside of the shell to an air inlet on a distal end of the air duct 60 located away from the shell 12 and of the teat cup 12. Thus the air drawn into the milk conduit 34 is taken from a remote location, not right next to the bottom of the teat cup 10. By providing a sealed connection between the air duct 60 and milk conduit about the air inlet 58 we provide an air inlet that is not exposed to exterior elements but is protected from and is not in fluid communication with them. As such, the air inlet 58 is not subject to obstruction or blocking or being soiled by external elements such as dirt. As described herein, the air inlet 58 and air duct 60 may be part of an overall air passage that is sealed from external elements such that the air flow may be protected from obstruction. This may be assured by drawing air from a location away from sources of obstruction, as well as by proving a filter or other structure at a distant air inlet to the air passage that prevents the accumulation of obstructing elements in the air passage or at the distant air inlet itself.

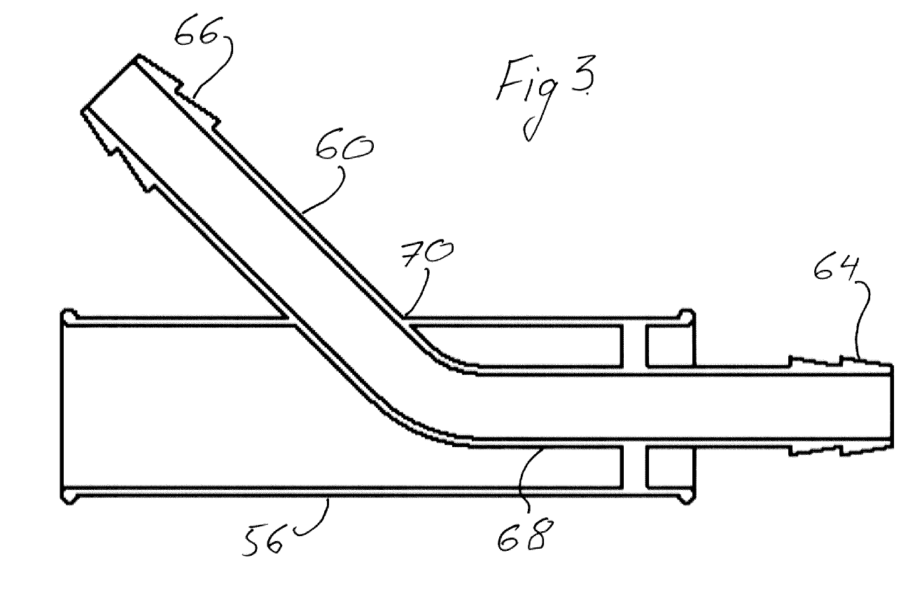

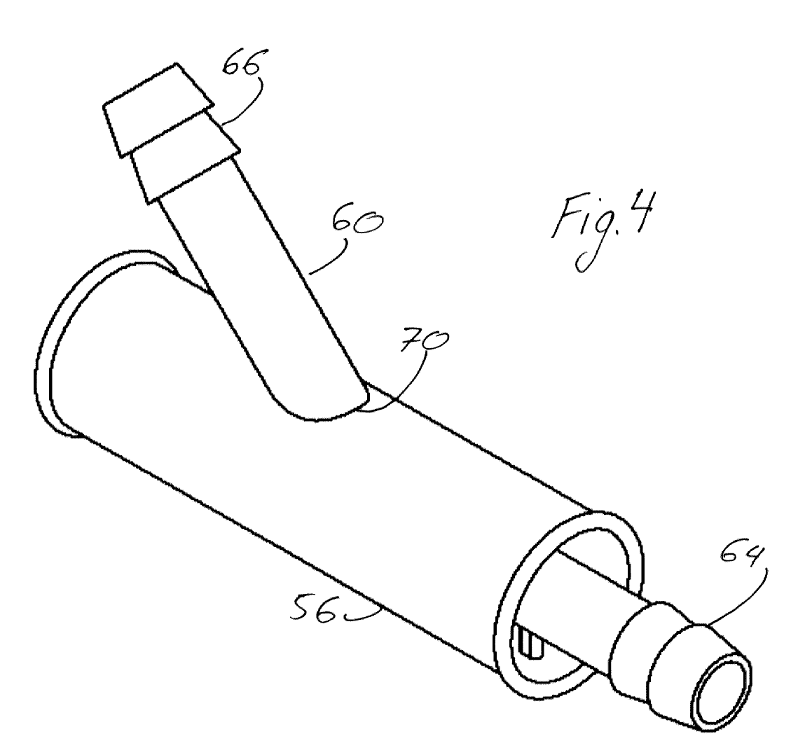

In particular, the air duct 60 may be part of a larger air passage system comprising the air duct 60 itself, as well as valve(s), filter(s), pump(s) and other duct(s) to control the flow, origin and purity of the air entering the milk stream. In the present example, the air duct 60 has a body forming a closed air pathway. In this context an air pathway is considered because within the pathway, that is to say between the ends of the pathway, the air is blocked from mixing with air from outside the pathway. Naturally, however, if the pathway is defined between two open ends, these can be open, e.g. to allow outside air to enter the pathway at an inlet and to exit the pathway at an outlet. In this example, the air duct body takes the form of a connecting pipe allowing the linking in fluid communication of the milk stream with an outside air source such as more distant air drawn from an area away from the impurities surrounding the teat cup or air from a filtered air system. In particular, as shown in FIG. 3 which is a side elevation cross-sectional view of the air duct 60 and the vacuum duct 56 of the example of FIG. 1, the air duct 60 comprises a connection 64 for connecting with the air inlet 58 and a connection 66 for connecting with a further duct or other air passage piece. As shown, the air duct 60 exits the interior of the teat cup, and more specifically the semi-enclosed space 38 defined by the shell 12 through the vacuum conduit 54 and more specifically it traverses the shell body through the vacuum port hole 55 and is partly contained within the vacuum duct 56. A portion 68 of the air duct 60 is contained within the vacuum duct 56. As better shown in FIG. 4, which is a perspective view of the air duct 60 and the vacuum duct 56 of the example of FIG. 1, the air duct 60 protrudes out of the vacuum duct 56 at a port 70 to allow it to be connected to external objects.

Connections may be permanent. It will be appreciated that the air duct 60 could be permanently connected to the milk conduit 34 at the air inlet 58, for example. For instance the two pieces, along with other parts of the shell 12, such as parts or all of the base 14, the vacuum duct 56, the milk duct 36, etc. . . . may be molded or 3D printed together.

In the present example, the air duct 60 is configured to be connected at the connection 66 to an air feed hose (not shown), and is so connected in use. The air feed hose may be part of a milking machine that is operating the milking head on which the teat cup 10 is used. The air feed hose, along with the air duct 60 and the inlet 58 are part of the overall air passage that connects the milk stream to an air source. In this particular example, the air feed hose connects the air duct 60 to an electronically-controlled valve that is controlled by the controller of the milking machine to vary and/or set the flow of air that is allowed to pass through and into the milk stream. On the other side of the valve, is another air hose that connects the valve to an air inlet where an air filter (e.g. HEPA filter) filters the incoming air to ensure that no impurities such as dust penetrate the air passage. Although the valve is electronically controlled in this example, a manual valve allowing a user to set the restriction on air flow could be used in other embodiments where the air flow is not to be modified frequently and/or during milking.

Although in some embodiments the system relies on the fluid dynamics, the venturi effect or the suction of the milk pump to draw air into the milk conduit 34, in certain embodiments it may be desired to include an air pump in the air passage, for example upstream of the valve and downstream of the filter. This may be useful if a very fine filter is used, for example to conform to certain food production standards, which restricts air flow or if the intaken air must be forced a long distance or towards many teat cups or if for any other reason the suction present at the inlet is insufficient. In the present example, an air pump is provided in the air passage to allow the application of a high airflow into the milk conduit. The air pump is electronically controlled by the milking machine controller. When milking is completed at one teat, the milking controller causes the pump to output a burst of air, and simultaneously controls the valve to permit the flow of this air so as to purge the milk conduit, including milk ducts of milk. Alternatively, the pump could output a constant pressure, the flow being controlled at the valve.

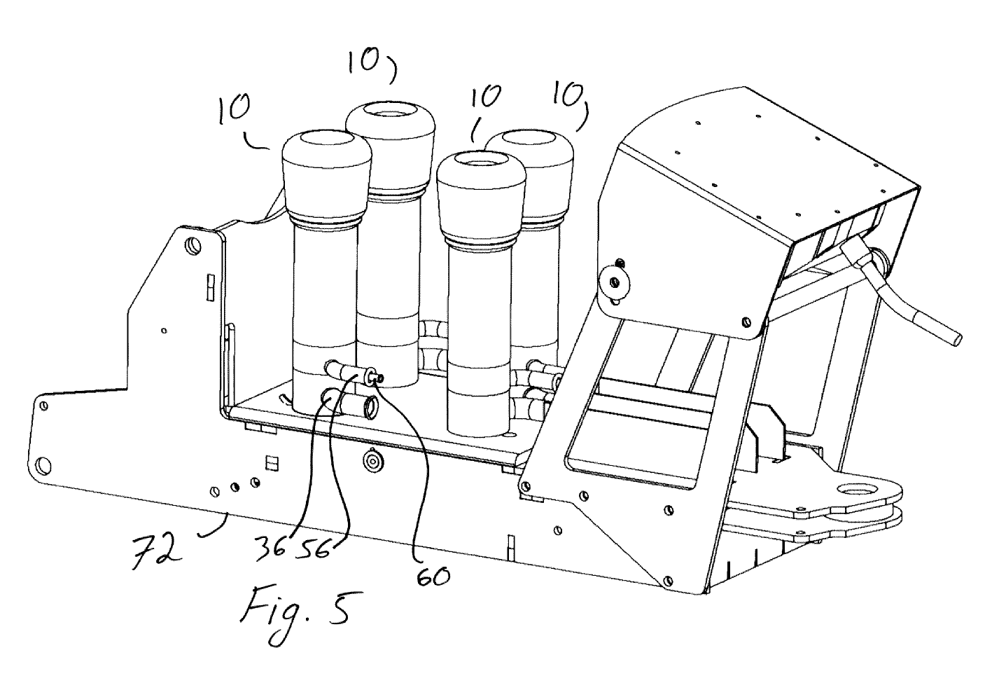

In a cow milking machine, a milk head may have four teat cups. Each may be identical or they may be differently dimensioned. Either way, they may each embody the present solutions described herein. When multiple teat cups are present, their respective air conduits may each belong to respective air passages with respective components (e.g. valve(s), filter(s), pump(s) and other duct(s)) or they may be interconnect by a manifold to a single air feed hose to provide a common air passage, e.g. such as the one described above, servicing all the teat cups simultaneously. While this prevents the individual control of airflow to each teat cup, it leads to a simpler and more cost effective design. In one particularly interesting solution, a single air filter receives and air pump feed via hoses and a manifold a plurality of teat cups (e.g. each of the teat cups for a milking head) but each teat cup has their individual air duct 60 fed via a respective valve which is electronically controlled to control the air flow at each teat cup. FIG. 5 shows a perspective view of a cow milking head 72 comprising four teat cups 10 each having their own air duct 60.

Although in the example illustrated here, the fluid connection between the air duct and the milk conduit 34 occurs via air inlet 58 in the milk duct 36, other configurations are possible. For example, the fluid communication between the two may occur through the teat-receiving space 62. Indeed, the teat-receiving space may itself form part of the milk conduit although the two are distinct here, and in certain embodiments such as in the through-sleeve embodiment described above, the transition from teat-receiving space to milk conduit may be gradual or the milk conduit may comprise a milk duct and a portion of the teat-receiving space. In some example, the air inlet 58 may be into the teat receiving space, nonetheless allowing fluid communication between the air duct and the milk conduit and even sealed fluid communication if the teat cup sufficiently seals against the teats and/or udder of the animal being milked.

Advantageously, the solution allows for drawing air away from the source of impurities near the ground under an animal. In one embodiment, the air source at the distal end of the air passage is located at an air inlet (not to be confused with air inlet 58) that is higher than the bottom of the teat cup where impurities may lie. In particular, the source air inlet may be located higher than even the top of the teat cup. The source air inlet may also be located horizontally away from the teat cup. Since the teat cup is generally placed under an animal to milk it, and is therefore in proximity to bodily ejecta, breath, parasites and other impurities, in certain embodiments, the air passage will be deliberately elongate to allow a source air inlet that is located horizontally away from the animal. Animals being typically milked in a (tie- or milking-) stall, the air passage may be configured to provide a source air inlet above the animal and/or outside of the stall.

In one particular example, a milking machine is a milking robot that autonomously secures cows or other animals in their stalls and automatically attaches one or more teat cup 10 to the teats of the animals to milk them. The air passage comprises a hose drawing air from a source air inlet located on the machine at a location that is above the animal and/or that remains in the hallway while the animal is being milked.

In another embodiment a milking machine is a milking parlour machine comprising a milking stall into which animals such as cows enter to be milked. Similarly the machine attaches one or more teat cup 10 to the teats of the animals to milk them. The air passage comprises a hose drawing air from a source air inlet located on a portion of the machine away from the milking stall, e.g. on the top opposite end of the machine.

In other examples, the milking machine may comprise or be located near a trench, e.g. an access trench for an operator to operate from a position lower than the floor on which the animal stands. This can occur, for example, where milking machines are operated by hand and a trench is provided for an operator to be at roughly shoulder level with, e.g., the udder of a cow to be milked, so that the operator may comfortably connect the teat cups to the teats. In such an example, the air inlet may be located in the trench, and therefore below the level of the teat cup and indeed of the floor, and yet still draw air from a cleaner location, away from the animal.

Teat cups in a milking robot are typically provided on a mobile milking arm that is displaced under the animal to be milked in order to affix the teat cups to the teats on the animal. In some embodiments, the air duct may be connected to the milking arm and extend e.g. through a hose or pipe that is provided on the milking arm. Thus by being provided on the milking arm, the air duct can draw air even further, having support from the milking arm. In some embodiments, the air duct can extend even further being affixed to and/or supported by the body of the milking robot. It is thus possible to draw air from away from even the milking arm, which itself is in proximity to the underside of the animal and the impurities of the animal and/or floor. By providing an air duct on the robot body and milking arm, it is possible to provide a sealed air passage to an inlet located away from the animal itself, and even away from the stall of the animal, where the robot body has a portion located outside the stall or at least a side facing outside the stall. In order to accommodate the movement of the milking arm, the air duct may be provided with at least one flexible portion. In one example, the air duct comprises a flexible hose portion at the articulation of the milking arm.

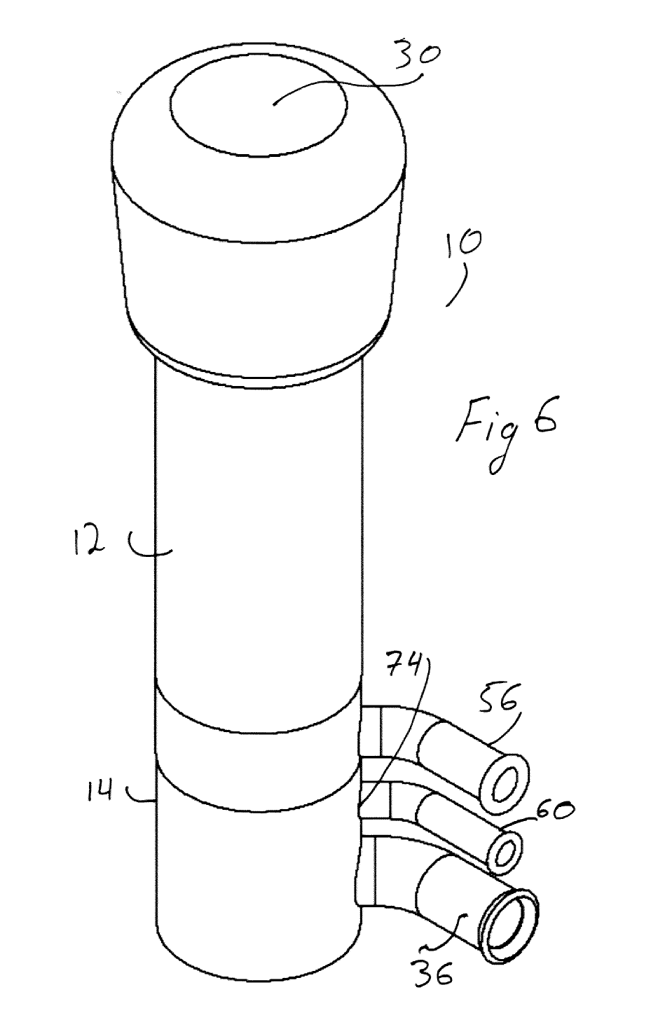

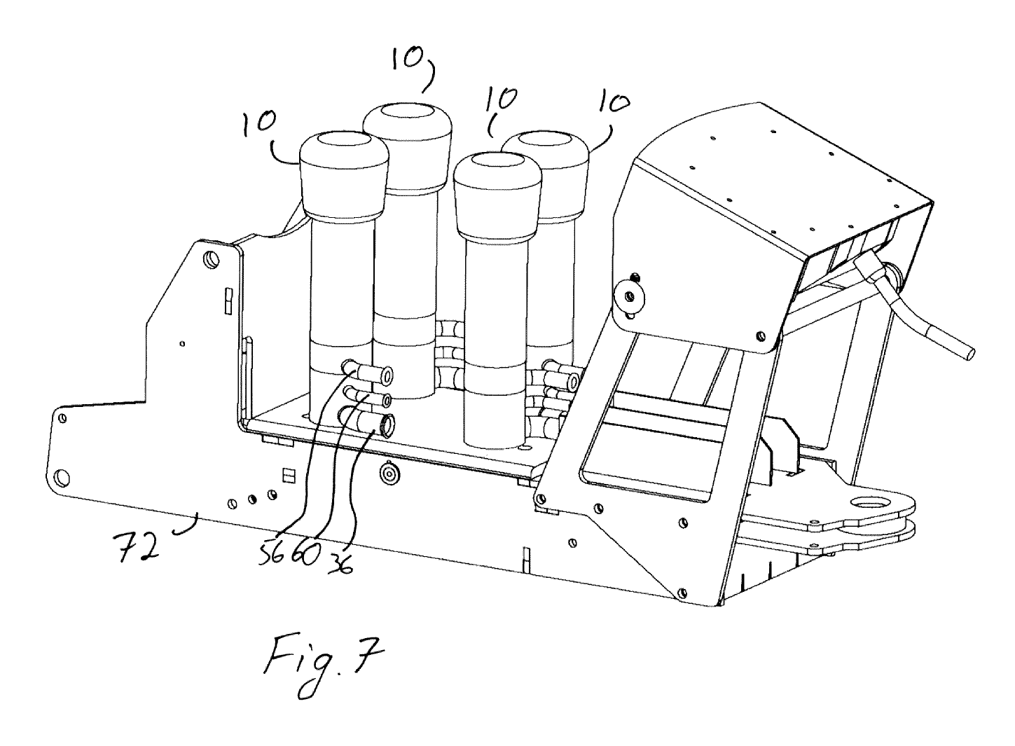

In the example provided above, the air duct 60 passed traversed the shell 12 of the teat cup 10 by passing through the inside of the vacuum duct 56 while not being in fluid communication with vacuum duct 56. In another embodiment, illustrated in FIG. 6, the air duct may be independent from the vacuum duct 56. To this end, the air inlet 58 may be located elsewhere along the milk conduit 34, such as lower on the milk conduit to allow the air duct to extend below (as shown) or simply not in the same location as the vacuum duct 56. In this example, the air duct connects to the shell 12 at its own porthole, air porthole 74 that is spaced apart on the shell 12 from the vacuum conduit 56. Similarly to the example of FIG. 1, the air duct here continues inside the shell 12 to the milk conduit 34 where it connects to it via air inlet 58. FIG. 7 shows the milking head 72 of FIG. 5 with teat cups according to this alternative embodiment.

In certain cases, as has been described above, the milk duct 36 may be embodied by an extension of the sleeve 24, such as when the sleeve is a through-sleeve. Nonetheless, an air duct may be provided in fluid communication with the milk conduit (e.g. in sealed fluid communication whereby their connection together is sealed). FIG. 8 illustrates an example teat-cup with a through-sleeve. In this particular example, the air duct 60 may connect directly to the milk duct that is an extension of the sleeve at an air inlet 58 which may be outside of the teat cup shell. Alternatively, the air duct may penetrate through the teat cup shell, for example in the manner shown in FIG. 1 or 6, and connect to the milk conduit formed by the sleeve or even to the teat-receiving space formed by the sleeve inside the shell.

As will be appreciated from the foregoing description, the described solution allows the drawing of air into the milk stream from away from the teat cup. In particular is provided a method for milking which may be implemented by a machine (e.g. milking machine or a milking head assembly) automatically controlled by an electronic controller.

A teat cup such as teat cup 10 of the example of FIG. 1 is placed around the teat of an animal and the animal is milked. In the milking a pulsating vacuum may be created in the chamber 48, e.g. by causing suction equipment that is present in or connected to the machine to apply a variable suction to a vacuum duct providing fluid communication between the suction equipment and the chamber 48. To do so the controller may be programmed to emit appropriate electronic signals to the cause the suction equipment to behave as described.

A suction is applied to the teat-receiving space 62 to draw milk from the teat. To do so the controller may be programmed to emit appropriate electronic signals to cause pumping equipment in fluid communication with the teat-receiving space via the milk duct to cause the pumping of milk from the teat-receiving space through the milk duct.

Finally, the method comprises drawing air into the milk duct from a location away from the teat cup. To do so may comprise providing an air passage or any portion thereof as described above, linking the milk duct to a source air inlet located away from the teat cup. Doing so may also involve controlling the air intake, for example by the controller being programmed to emit electronic signals causing a valve in the air passage. Alternatively or supplementally, controlling the air intake may involve controlling air pumping equipment, e.g. by a controller programmed to emit electronic signals to direct the pumping of air by the air pumping equipment. The air may be drawn from a source location above the base of the teat cup, above the top of the teat cup, or elsewhere as already described herein.

The method may also involve filtering, e.g. using a filter at the source air inlet (or elsewhere in the air passage) as described above, to remove impurities from the air before it enters the milk duct.

As described, an air pump may be used to cause a flow in the air passage. As such, air blowing equipment may be provided. The method may involve electronically controlling the air blowing equipment to cause the flow of air to blow into the milk duct, e.g. to purge the milk duct of excess milk contained therein, e.g. after milking is complete. To do so the controller may be programmed to emit electronic signals to cause the air blowing equipment to function as described.

Although the teat cup of this example has been shown as having a cylindrical construction with a base that is also cylindrical and provided as a separate assembled part, it will be appreciated that other forms are possible and that the term circumambient is not intended to imply a necessarily cylindrical shape and the term base is not intended to imply a necessarily separate part. Other variations may be apparent to a person skilled in the art.

As described, the present invention may be used in the context of a milking machine, which may be an autonomous or semi-autonomous robot. Other examples of milking machines exist, however. Some traditional milking machines are manually operated. These milking machines may be little more than a milking head, sometimes called distributor, that holds teat cups, along with pumping equipment, vacuum lines and milk lines. Such a manually operated machine may include a milk reservoir for storing pumped milk, and may also comprise cleaning equipment for cleaning parts of the machine or the animal or environment.

In certain embodiments, it may be preferable to provide the air inlet not directly on or in the teat cup or sleeve but further down the milk line. In particular, a milking head may comprise a plurality of teat cups each having a milk line connected thereto. A milk line may be the milk duct of a teat cup, or may be a separate hose or like conduit connected to the milk duct of a teat cup. The milk line may connect the teat cup to a milk reservoir, which may be provided within the milking machine, e.g. when the milking machine is a mobile self-contained manually operated milking machine that can be transported to the animal to milk. Alternatively, the milk line may link teat cups to a milk reservoir at a remote location from the milking head. For example in a tie-stall barn, a single reservoir may be provided in the barn with conduits extending towards the stalls. In that example, individual milking heads may be provided at each stall or a single milking machine or milking head may be moved from stall-to-stall, e.g. by an operator, and connected to the conduit to pump milk from the barn's reservoir.

Taking the example of a mobile self-contained manually-operated milking machine for illustration, the air inlet 58 which in the first example was provided within the milk duct 36 of the teat cup 10 may instead be provided in the milk passage, e.g. the milk line. In this example the milk line may be a rubber hose that connects to the milk duct 36 of a teat cup. Thus the air duct 60 may protrude from the milk line rather than from the teat cup. In other respects, the air duct may be provided in similar manner and configuration as described herein. That is to say it may extend away from the milk passage for drawing air from a cleaner location, it may be provided to an air passage system comprising a valve, air filter and/or air pump. Advantageously, this allows the advantages of the invention to be provided while maintaining compatibility with standard teat cups and/or sleeves.

Thus in one non-limiting embodiment is provided a milking head comprising a milk passage, e.g. a milk line, in fluid communication with the teat cup to which is provided an air inlet connected to an air duct for drawing air away from the teat cup and even away from the milking head itself and from the animal being milked. By providing an air filter, valve and/or pump in the air passage to which the air duct belongs, the milking head may also be configured to provide filtered air and controlled air flow into the milk line.

In certain milking heads, the milk lines of plural teat cups may be connected by a milk line junction, e.g. a manifold-like structure, that joins the milk lines of individual teat cups into a single combined milk line for transporting milk from each teat cup downstream, e.g. towards a reservoir. In another non-limiting embodiment, the air inlet and air duct may be provided in the combined milk line. Advantageously, this reduces the mechanical complexity and cost of the milking head. On the other hand, it removes the possibility of controlling inlet air flow for individual teat cups and may lead to unbalanced suction forces on each teat cup.

Although we have provided examples where the air duct provides air directly to the milk line, it should be understood that the milk line may be part of a broader milk passage which connects teat cups downstream, e.g. from the teat-receiving space to a milk reservoir. The overall milk passage may itself comprise one or more reservoir, for example certain milk heads comprise a small buffer reservoir within them close to the teat cups. Instead of being provided on the milk lines of the teat cups or on a combined milk line, the air duct and air inlet may be provided elsewhere in the milk passage. For example the air inlet may be provided in the reservoir with the air duct being provided to the reservoir to create an air conduit leading away from the reservoir. In one particular design of a cow milking head, the milk ducts of four teat cups join in a buffer reservoir near the base of the teat cups. In yet another non-limiting embodiment is provided a milking head having a buffer reservoir to which is connected at least one but in this example a plurality of teat cups and in which is provided an air inlet connected to an air duct for drawing air away from the teat cup and even away from the milking head itself and from the animal being milked. Here too, by providing an air filter, valve and/or pump in the air passage to which the air duct belongs, the milking head may also be configured to provide filtered air and controlled air flow into the milk line.

What is claimed is:

1. A teat cup comprising:
a. a shell having an upper aperture and a milk conduit and defining a semi-enclosed sleeve-receiving space therebetween, the semi-enclosed sleeve-receiving space being sealable against the shell and the milk conduit by a flexible sleeve to define a chamber between the shell and the flexible sleeve;
b. a vacuum conduit defining a fluid passage from the chamber to the exterior of the shell such that the application of a suction to the fluid passage causes a vacuum to be applied within the chamber;
c. an air duct having a first end in fluid communication with the milk conduit and a duct body extending outside of the shell from the milk conduit to a second end located away from the shell of the teat cup creating a closed air pathway from the second end to the milk conduit for communicating air located away from the teat cup with the milk conduit.

2. The teat cup of claim 1, wherein the air duct is configured to form part of an air passage that extends between the milk conduit and an air inlet.

3. The teat cup of claim 2, comprising the air passage, the air passage extending between the milk conduit and the air inlet located at a position vertically above the bottom of the teat cup when the teat cup is in milking operation so as to draw air from further away from the floor than the bottom of the teat cup.

4. The teat cup of claim 3, wherein the air passage extends between the milk conduit and the air inlet located at a position vertically above the top of the teat cup when the teat cup is in milking operation so as to draw air from further away from the floor than the top of the teat cup.

5. The teat cup of any of claims 2-4, comprising the air passage wherein the air passage extends between the milk conduit and the air inlet located at a location that is horizontally away from the teat cup when the teat cup is in milking operation to a distance beyond the range of excrement for the animal being milked.

6. The teat cup of any of claims 2-5, wherein the teat cup is configured for mounting on a milking robot that is configured to milk an animal in an animal enclosure, wherein the air passage comprises a hose extending to an air inlet located away from the ground of the animal enclosure.

7. The teat cup of claim 6, wherein the milking robot comprises a milking arm for holding the teat cup, wherein the air duct extends along the milking arm away from the teat cup.

8. The teat cup of any of claims 2-7, comprising the air passage, the air passage comprising a valve for regulating the flow of air allowed to be introduced into the milk conduit via the air duct.

9. The teat cup of any of claims 2-8, comprising the air passage, wherein the air passage comprises an air filter for filtering impurities from air received in the air passage from the inlet.

10. The teat cup of claim 2, wherein the air duct comprises a connector for creating a sealing connection with an external air passage component.

11. The teat cup of any of claims 1-10, wherein the first end of the air duct is located inside the semi-enclosed space defined by the shell and the air duct extends outside of the shell through the vacuum conduit.

12. The teat cup of claim 11, further comprising a vacuum duct connecting to the shell at a vacuum port hole forming the vacuum conduit, wherein the air duct traverses the shell through the vacuum port hole and is at least partly contained within a the vacuum duct.

13. The teat cup of any of claims 1-10, wherein the air duct extends through the shell via an air porthole that is spaced apart on the shell from the vacuum conduit.

14. The teat cup of any of claims 1-13, wherein the shell comprises a base, circumambient outer wall extending between the base and the upper aperture, the circumambient outer wall and the base defining the semi-enclosed sleeve-receiving space.

15. The teat cup of claim 14, wherein the circumambient outer wall comprises a lip around the upper aperture for frictional sealing contact with the sleeve.

16. The teat cup of any of claims 1-15, wherein the milk conduit comprises a milk duct having a source aperture within the semi-enclosed sleeve-receiving space for sealing with the flexible sleeve, the milk duct extending outward from the shell for drawing milk towards a milk pump located outside of the teat cup.

17. The teat cup of any of claim 1-16, wherein the air duct is a purge duct suitable for receiving an external air flow and directing the flow into the milk conduit to purge the milk conduit of excess milk contained therein.

18. A teat cup sleeve for lining the inside of a teat cup shell of a teat cup comprising:
a. a first longitudinal end comprising a teat-receiving opening and a mouth configured to form a seal around an upper aperture of the teat cup shell;
b. a circumambient flexible wall extending longitudinally from the first longitudinal end towards a second longitudinal end and defining a teat-receiving space;
c. a milk conduit extending outwards at the second longitudinal end to traverse the teat cup shell when installed for drawing milk away from the teat-receiving space towards a milk pump located outside of the teat cup;
d. an air duct having a first end in sealed fluid communication with the milk conduit having a duct body extending outside of the sleeve to a second end located distally away from the sleeve such that when the sleeve is installed in a teat cup shell the air duct body extends away from the teat cup and creates a closed air pathway from the second en to the milk conduit for communicating air located away from the teat cup with the milk conduit.

19. The teat cup sleeve of claim 18, wherein the milk conduit comprises a milk duct and at least a portion of the teat-receiving space.

20. The teat cup sleeve of claim 19, wherein the milk duct comprises a hose-shaped extension of the teat cup sleeve.

21. The teat cup sleeve of any of claims 18-20, wherein the air duct is configured to form part of an air passage that extends between the milk conduit and an air inlet.

22. A teat cup comprising:
a. an outer wall;
b. a flexible inner wall;
c. a chamber between the outer wall;
d. a vacuum conduit defining a fluid passage from the chamber across the outer wall such that the application of a suction to the fluid passage causes a vacuum to be applied within the chamber;
e. a teat-receiving space inside the flexible inner wall;
f. a milk duct outwards from the teat-receiving space for drawing milk away from the teat-receiving space towards a milk pump located outside of the teat cup;
g. an air duct having a first end in sealed fluid communication with the milk duct and a duct body extending outside of the shell from the milk conduit to a second end located away from the shell of the teat cup creating a closed air pathway from the second end to the milk conduit for communicating air located away from the teat cup with the milk conduit.

23. A method of producing milk by milking an animal comprising:
a. placing a teat cup having an outer wall, a flexible inner wall, and a chamber therebetween around a teat of the animal such that the teat penetrates a teat-receiving space defined at least in part by the inner wall;
b. creating a pulsating vacuum in the chamber;
c. applying suction to the teat-receiving space to draw milk into a milk duct away from the teat towards a milk reservoir;
d. drawing air into the milk duct from a location away from the teat cup.

24. The method of claim 23, wherein drawing air into the milk duct comprises setting controlling the air intake entering the milk duct.

25. The method of claim 24, wherein controlling the air intake comprises electronically controlling a valve located in an air passage creating a fluid connection between the milk duct and an air inlet.

26. The method of any of claims 23-25, wherein drawing air into the milk duct comprises providing an air passage creating fluid communication through a closed air pathway between the milk duct and an air inlet located away from the teat cup.

27. The method of any of claims 23-26, wherein drawing air into the milk duct comprises filtering the air with an air filter to remove impurities from the air before it enters the milk duct.

28. The method of any of claims 23-27, wherein creating a pulsating vacuum comprises electronically controlling suction equipment to apply a variable suction to a vacuum duct providing fluid communication between the suction equipment and the chamber.

29. The method of any of claims 23-28, wherein applying suction to the teat-receiving space comprises electronically controlling pumping equipment in fluid communication with the teat-receiving space via the milk duct to cause the pumping of milk from the teat-receiving space through the milk duct.

30. The method of any of claims 23-29, further comprising electronically controlling air blowing equipment to cause a flow of air to blow into the milk duct to purge the milk duct of excess milk contained therein.

31. The method of any of claims 23-30, wherein drawing air into the milk duct comprises drawing air from a location above the base of the teat cup.

32. The method of any of claims 23-31, wherein drawing air into the milk duct comprises drawing air from a location above the top of the teat cup.

33. The method of any of claims 23-32, wherein said milk is cow's milk.

34. A milking robot comprising animal processing equipment including a milking head, the milking robot comprising:
a. at least one teat cup provided on the milking head;
b. a milk conduit for drawing milk away from an interior of the teat cup;
c. an air passage having a first end in fluid communication with the milk conduit and extending to a second end located away from the teat cup creating a closed air pathway from the second end to the milk conduit for communicating air located away from the teat cup with the milk conduit.

35. The milking robot of claim 34, wherein the air passage comprises a proximal end located at the teat cup and a distal end located away from the teat cup, the milking robot comprising an air inlet at the distal end of the air passage and at least an air duct creating a sealed fluid communication between the air inlet and the teat cup.

36. The milking robot of claim 35, wherein the milking robot is configured to milk an animal in an enclosure, the air inlet being provided on a portion of the milking robot that remains outside of the enclosure during milking operations.

37. The milking robot of claim 36, further comprising a milking arm for holding the teat cup, wherein the air passage extends along the milking arm away from the teat cup.

38. A milking head comprising:
a. at least one teat cup,
b. a milk passage in fluid communication with the teat cup;
c. a vacuum conduit defining a fluid passage to the teat cup for providing thereto a pulsating vacuum;
d. an air duct having a first end at an air inlet in the milk passage and extending to a second end located away from the milk passage creating a closed air pathway from the second end to the milk conduit for communicating air located away from the milk passage with the milk passage.

39. The milking head of claim 38, wherein the air duct is configured to form part of an air passage that extends between the milk passage and an air inlet.

40. The milking head of claim 39, comprising the air passage wherein the air passage extends between the milk passage and the air inlet located at a location that is horizontally away from the milking head when the milking head is in milking operation to a distance beyond the range of excrement for the animal being milked.

41. The milking head of any of claims 39-40, comprising the air passage, the air passage comprising a valve for regulating the flow of air allowed to be introduced into the milk conduit via the air duct.

42. The milking head of any of claims 39-41, comprising the air passage, wherein the air passage comprises an air filter for filtering impurities from air received in the air passage from the inlet.

43. The milking head of any of claims 38-42, wherein the milk passage comprises a buffer reservoir, the air inlet being provided in the buffer reservoir and the air duct being connected to the buffer reservoir at the air inlet.

44. The milking head of any of claims 38-42, wherein the milk passage comprises a milk line in connection with the at least one teat cup, the air inlet being provided in the milk line and the air duct being connected to the milk line at the air inlet.

45. The milking head of claim 44, wherein the at least one teat cup comprises a single teat cup and the milk line is connected to the single teat cup.

46. The milking head of claim 44, wherein the at least one teat cup is a plurality of teat cup and the milk line is a combined milk line in fluid communication with each of the plurality of teat cups.

47. The milking head of claim 38, wherein the milking head is disposed on a milking arm, wherein the air passage extends along the milking arm.
